(19) United States
(12) Patent Application Publication
(10) Pub. No.: US 2024/0263267 A1
(43) Pub. Date: Aug. 8, 2024

(54) METHOD AND SYSTEM FOR THERMAL DECOMPOSITION WITHIN A VACUUM OR A NONREACTIVE CHAMBER

(71) Applicant: Andrew Haverly, Boulder, CO (US)

(72) Inventor: Andrew Haverly, Boulder, CO (US)

(21) Appl. No.: 18/432,000

(22) Filed: Feb. 4, 2024

Related U.S. Application Data
(60) Provisional application No. 63/443,703, filed on Feb. 6, 2023.
(60) Provisional application No. 63/445,821, filed on Feb. 15, 2023.

(51) Int. Cl. C22B 5/02; F27D 15/02

(52) U.S. Cl. CPC C22B 5/02; F27D 15/0266

(57) ABSTRACT

The present invention is a system for thermal decomposition or material comprising: a release mechanism; a cooling surface positioned relative to the release mechanism; and a heat source, wherein the heat source is focused relative to the release mechanism and the cooling surface; wherein a quantity of material is released from the release mechanism and is heated by the heat source, wherein a product is produced and the product is transferred to the cooling surface.

### CROSS-REFERENCE TO RELATED APPLICATIONS

This application is a continuation-in-part (and claims the benefit of priority under 35 USC 120) of U.S. application No. 63/443,703 filed Feb. 6, 2023, and U.S. application No. 63/445,821 filed Feb. 15, 2023, currently pending. The disclosure of the prior applications is considered part of (and is incorporated by reference in) the disclosure of this application.

### BACKGROUND OF THE INVENTION

The present invention relates to decomposition of a compound, and more particularly to the process of decomposing a compound in a vacuum.

Thermolysis is a process by which a material undergoes thermal decomposition into smaller molecules, without the need for oxygen or any other chemicals. Thermolysis of a given material can produce many different thermal decomposition products, called thermolysis products.

There is little-to-no state of the art for purifying metals in space besides the standard smelting process we have been using on Earth for thousands of years. As we continue to focus on establishing lunar and Martian bases, as well as asteroid mining, we need a non-smelting method of purifying metals and other chemicals in space.

The current solution for metal refining in a similar manner is smelting. Smelting involves a reduction reaction in which a metal oxide reacts with another chemical (usually carbon monoxide) to extract the metal from the ore. Thermal decomposition has no practice or development simply because smelting is more efficient and easier to perform on Earth. However, in space, carbon monoxide is rare (as are other chemicals for reduction). This method of metal purification will be an easier way to produce usable metals out of the metal oxides present.

It is desired to have a method and system that can perform the thermal decomposition of a substance that can operate in a vacuum, so that the method and system can be used on a celestial body or elsewhere beyond Earth, hereinafter “outer space”.

### SUMMARY

Accordingly, in a first embodiment, the present invention is a system for thermal decomposition of material comprising; a release mechanism; a cooling surface positioned relative to the release mechanism; and a heat source, positioned relative to the release mechanism and the cooling surface; wherein a quantity of material is released from the release mechanism and is heated by the heat source, wherein a product is produced and the product is transferred to the cooling surface.

Accordingly, in a second embodiment, the present invention is a system for thermal decomposition of material comprising: a release mechanism; a cooling system positioned relative to the release mechanism, wherein the cooling system comprises, a conveyor belt, a drive mechanism connected to the conveyor belt, and a heat source, wherein the heat source is focused relative to the release mechanism and the cooling system; wherein a quantity of material is released from the release mechanism and is heated by the heat source, wherein a product is produced and the product is transferred to the cooling system.

Accordingly, in a first embodiment, the present invention is system for thermal decomposition of material comprising: release mechanism; a cooling system positioned relative to the release mechanism; a heat source, positioned relative to the release mechanism and the cooling system; a sorting system positioned relative to the heat source and the cooling system; and wherein a quantity of material is released from the release mechanism and is heated by the heat source, wherein a product is produced and the product is transferred to the cooling system.

### BRIEF DESCRIPTION OF THE DRAWINGS

FIG. 1 depicts an illustration of a decomposition system, in accordance with an embodiment of the present invention.

FIG. 2 depicts an illustration of the decomposition system, in accordance with another embodiment of the present invention.

FIG. 3 depicts an illustration of the decomposition system, in accordance with another embodiment of the present invention.

FIG. 4 depicts an illustration of the decomposition system, in accordance with another embodiment of the present invention.

FIG. 5 depicts an illustration of the decomposition system, in accordance with another embodiment of the present invention.

FIG. 6 depicts an illustration of the decomposition system, in accordance with another embodiment of the present invention.

FIG. 7 depicts an illustration of the decomposition system, in accordance with an embodiment of the present invention.

FIG. 8 depicts an illustration of a release system of the decomposition system, in accordance with an embodiment of the present invention.

### DETAILED DESCRIPTION OF THE INVENTION

The present invention provides a method and a system that allows for the decomposition of a compound to extract different materials or elements from the compound. The decomposition can be accomplished through the use of thermal energy or chemical reactions. The method and system are used, in some instances, to purify usable materials from an extraterrestrial object. This process can be performed within a vacuum or within a non-reactive or vacuum chamber.

This is advantageous for a number of reasons, in that the method can be performed on an extraterrestrial object to produce various metals, chemicals, or pure elements from matter found on said extraterrestrial object with minimal parts/components and do not require the transportation of said metals, chemicals, or pure elements to the extraterrestrial object. This removes the need to transport these materials to the extraterrestrial object. For example, if the extraterrestrial object has rich iron deposits in the soil, the present invention can extract that iron and collect it in a useable state. The present invention is described as being performed in a vacuum. This may be within a chamber or on an extraterrestrial object which has an atmosphere that is similar to a vacuum.

Another advantage to the present invention is if the system uses the sun (or a star) to provide the thermal energy, the system may only need small amounts of electricity to run, and in many embodiments, requires no electricity. The system can also incorporate solar panels or devices which can convert the sunlight into electricity to power the various electrical components of the system, which may include the heat source. This is advantageous because it creates a minimalist system that can be set up on an extraterrestrial object and operate independent without the need of non-renewable power sources.

Through the use of the method and system described herein, the thermal decomposition of a compound found on an extraterrestrial object can produce purified and usable metals or other materials from the decomposition process described below.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

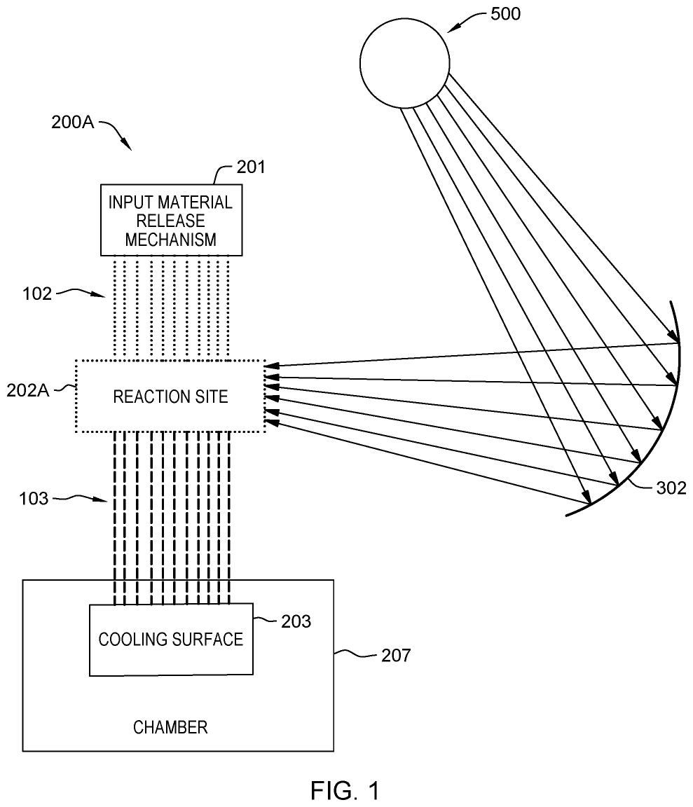

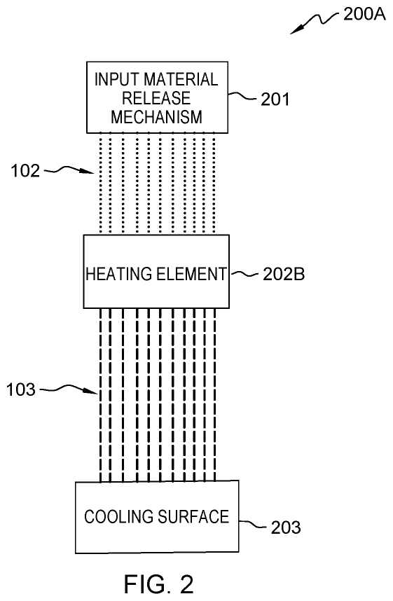

FIGS. 1 and 2 depict illustrations of the decomposition system 200A, in accordance with embodiments of the present invention. The decomposition system 200A consists of an energy source either a sun or star 500 (FIG. 1) or a heating element 202B (FIG. 2), a release mechanism 201, and a cooling system 203. In the present embodiment, the energy source 500 uses a parabolic (or non-parabolic) reflector 302 to capture the sun's 500 direct solar radiation over a large surface area and focus or concentrate it onto a focal point or area (hereinafter referred to as “focal point”) increasing the magnitude of the solar radiation to perform the decomposition of the compound or input material 102 (hereinafter “input material 102”) through the heat generated. Various types of reflectors 302 can be used. In one embodiment, the concentrated light reaches temperatures of up to and/or beyond 4770K. Through the use of the parabolic reflector 302, the energy is able to be focused to a predetermined area and a predetermined location based on the parabolic reflector 302 design. In the depicted embodiment, the reaction site 202A is located based on the material release mechanism 201 and the cooling surface 203 position. The release mechanism 201 releases the input material 102 (soil, regolith, bedrock, etc.) through the focused thermal energy to allow the reaction to occur which produces the product which is captured on the cooling surface 203. The energy source 500 of the sun may be replaced with another heat source or heating element 202B capable of producing the required heat to perform the decomposition process of the input material 102. In one embodiment, the heating element 202B may be a heating coil, furnace, or the like which heats the input material 102 falling through it to the desired temperature and to the desired state.

The release mechanism 201 is positioned relative to the cooling surface 203 so as to not interfere with the reaction site 202. The release mechanism 201 may operate in a variety of methods to produce the desired flow rate of the input material 102, such as, but not limited to, a hopper, an Archimedes screw, or a conveyor belt. Based on the overall design of the system and the energy requirements, the release mechanism 201 can have a variety of designs. The release mechanism 201 may be manually operated or may have an integrated system to control the operation of the device.

Based on the desired particle size, the temperature at the focal point, and the area of the focal point, the release mechanism 201 releases the input material 102 at a predetermined rate per second that allows the decomposition of the input material 102 to occur. As the input material 102 passes through the reaction site 202, the chemical/physical change of the input material 102 occurs and the by-product(s) is/are captured on the cooling surface 203 or in additional devices or storage containers.

In some embodiments, the release mechanism 201 has a mechanism or system to alter the state of the input material 102 so that a desired particle size is achieved through either smashing or crushing the input material 102. The release mechanism 201 is able to determine the particle size of the input material 102 to confirm that a desired particle size is achieved.

The cooling surface 203 is made of a material either similar to the by-product, product, or purified product (hereinafter “product 103”) or of a material which is able to withstand the heat of the product 103 and allow for the extraction of the by-product from the cooling surface 203. In the depicted embodiments, the cooling surface 203 is a stationary object which catches the product 103 as it falls. In the depicted embodiment, there is a chamber 207 surrounding the cooling surface 203 to recapture other by-products of the decomposition. For example (as shown below) oxygen may be a by-product and is able to be captured within the chamber 207. The by-product, in this example oxygen, is then able to be extracted from the chamber 207 and stored remotely in a tank or the like.

On an extraterrestrial object, the surface soil, regolith, or if accessible bedrock may have metal(s) as a component of the surface soil, regolith, or if accessible bedrock and this method and system can extract said metal(s) to create a pure and usable embodiment of the metal(s).

In one embodiment, on the Moon, which on the surface is a near perfect vacuum, the method and system can be used to extract metals from the surface of the moon. The chemical composition of lunar regolith is shown below:

| | Range of the |
|---|---|
| | Percent of the |
| | Composition |
| Chemical | (%) |
| SiO₂ | 42-50 |
| Al₂O₃ | 11-14 |
| TiO₂ | 5-9 |
| FeO | 13-17 |
| MgO | 7-10 |
| CaO | 9-12 |
| Na₂O | <1 |
| K₂O | <1 |
| MnO | <1 |

The regolith from the Moon's surface is placed within the release mechanism 201, which releases the input material 102 at a predetermined flow rate over the cooling surface 203 which passes through the focal point (within the reaction site 202A) of the thermal energy. As the input material 102 falls from the release mechanism 201 to the cooling surface 203, the input material 102 passes through the reaction site 202 and the input material 102 is heated to or above the required temperature for the decomposition of the input material 102 to occur to form the product 103. The product 103 then interacts with the cooling surface 203 and solidifies, where other gaseous by-products are released into the environment or are captured in chamber(s) 207.

For example, the reactions (below) show how the Hematite, Magnetite, and Wustite, all found in the regolith of the moon, through thermal decompositions, produce a product (e.g. a metal, alloy, or metal compound) and oxygen.

$$6 {Fe}_{2} {O}_{3 ( s )} = 4 {Fe}_{3} {O}_{4 ( s )} + {O}_{2 ( g )} \\ 2 {Fe}_{3} {O}_{4 ( s )} = 6 {FeO}_{( l )} + {O}_{2 ( g )} \\ {FeO}_{( l )} = {Fe}_{( l )} + {O}_{2 ( g )}$$

Ellingham Diagrams can be used to show the temperature dependence of the stability of compounds to determine the desired heat required for the reduction of metal oxides and sulfides. Some other thermal decompositions are shown for exemplary purposes that this design can be used for are shown in various Ellingham diagrams based on the metal or compounds involved in the reaction. This shows the relationship between a reaction, the temperature, and the partial pressure of oxygen. Here we can see that at a partial pressure of oxygen=10^{-27.5}, the temperature required for Al₂O₃ to thermally decompose into Al and O₂ is approximately 1290° C. These diagrams can be used for titanium dioxide, carbon dioxide, silicon dioxide, calcium oxide, magnesium oxide, and all of the iron oxide reactions. All of the oxides in these Ellingham diagrams can be thermally decomposed using the method this patent describes. For additional elements, different Ellingham diagrams can be used to determine the relationship between the partial pressure of oxygen and the temperature required at the focal point.

The product 103 that is formed from the reaction comes in contact with the cooling surface 203, and in some of the examples above oxygen is a product. Based on the location of where the reaction occurs relative to the release mechanism 201 and the cooling surface 203, the product 103 may fall a distance before it comes in contact with the cooling surface 203. This distance from where the product 103 is formed and the cooling surface 203 is of a predetermined distance so that the product 103 is at predetermined temperature before coming in contact with the cooling surface 203. This may be because the product 103 is in a molten material or plasma so that it continuously adds to the previously accumulated product 103 on the cooling surface 203 to create one large mass of the product 103. In other embodiments, where multiple masses of the product 103 are desired the distance from the reaction site to the cooling surface 203 may be different. As shown in the depicted embodiment in FIG. 1, a chamber 207 surrounds the cooling surface 203 to capture the oxygen (or other gaseous) by-product. Once the desired amount of the product 103 is collected, it can either be removed from the cooling surface, or in some embodiments the cooling surface may be said product 103 and thus the newly collected purified material is added to the cooling surface 203 which is either removed in sections or in its entirety and a new cooling surface 203 is placed to begin the collection of the newly formed product 103.

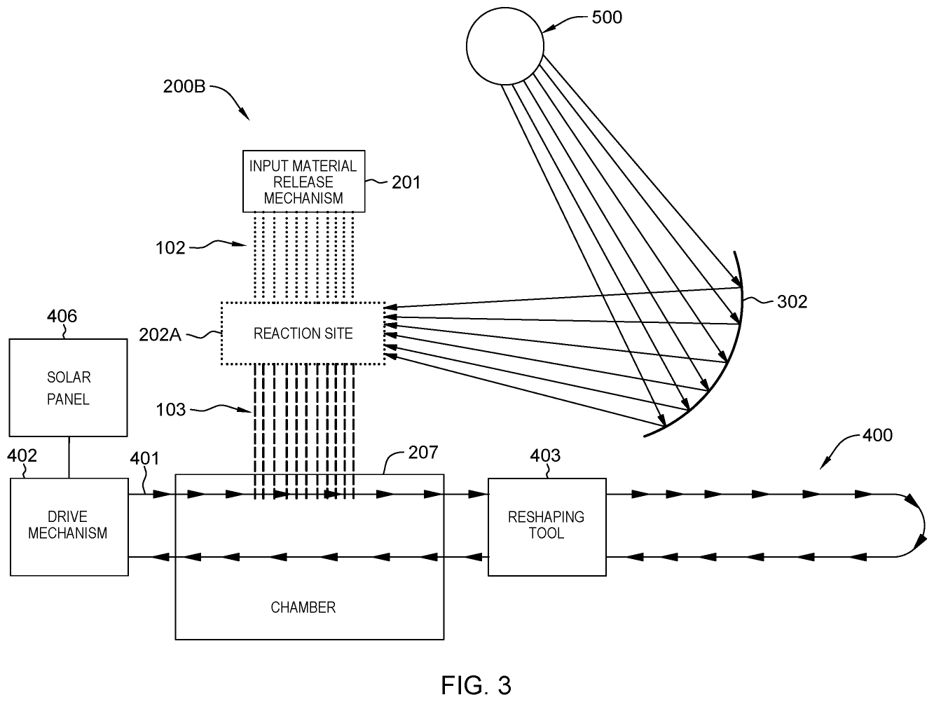

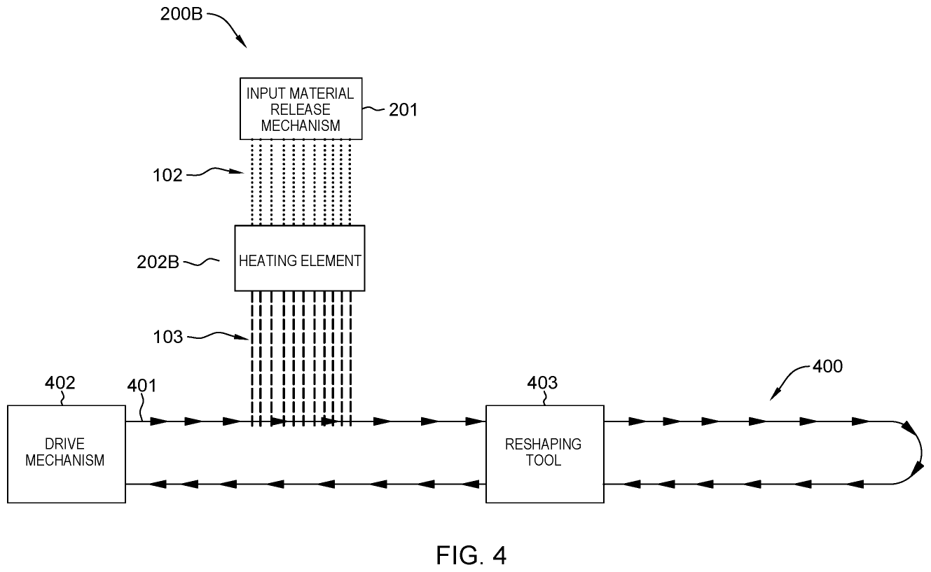

Depicted in FIGS. 3 and 4 are embodiments of the decomposition system 200B, in accordance with embodiments of the present invention. The decomposition system 200B has the release mechanism 201, the reaction site 202A (e.g. focal point) (FIG. 3) or the heating element 202B (FIG. 4) for the chemical or physical reaction to occur and a cooling surface system 400. The cooling surface system 400 has a ribbon 401 that passes underneath the reaction site 202A or the heating element 202B and the product 103 which interfaces with the ribbon 401 is moved away from the falling product 103. The ribbon 401 may be made from various materials, having varying thickness and width based on the product 103 properties. The ribbon 401 can be made from the same material as the product 103. So that the ribbon 401 can be flattened or reshaped (by the reshaping tool 403) to be fed back into the cooling surface system 400 or removed and used as desired. The ribbon 401 may be made from a flexible material. In the embodiments where the ribbon 401 is made from the same material as the product 103, the ribbon is of a thickness to allow for bending and flexing of the ribbon 401 without breaking. There is a drive mechanism 402 to control the speed and direction at which the ribbon 401 moves. The drive mechanism 402 either has a mechanical or electrical system to move the ribbon 401. The drive mechanism 402 may have integrated solar panel 406 or devices which can convert the sunlight into electricity to power the drive mechanism 402 and other electrical components within the system. In the depicted embodiment, the solar panel 406 is shown electrically connected to the drive mechanism 402. The solar panel 406 in the depicted embodiment incorporates the necessary components to collect, store, and convert the electricity for use within the system and for all the connected devices, this may include, but not limited to, a charge controller, a battery, an inverter, and the like. The solar panel 406 may be a single panel or an array of panels based on the required electricity to run the system or each component.

A reshaping tool 403 is incorporated into the cooling surface system 400 to provide a post processing of the product 103. This may be flattening, reshaping, smoothing, cutting, or otherwise modifying the product 103 which is produced at the reaction site 202. In the depicted embodiment, the ribbon 401 extends beyond the reshaping tool 403 to allow for cooling of the product 103 and/or removal of the product 103 from the cooling surface. In the depicted embodiment, a chamber 207 is shown around a section of the ribbon 401 to allow for the capture of gaseous by-products but may also be used to keep the product 103 at a predetermined temperature or physical state to allow for the reshaping tool 403 to be able to reshape the product 103 before it cools and hardens. The present invention can also be used to induce both physical and chemical reactions, such as, but not limited to non-oxide compounds and non-chemical changes in a material. For example, this invention can be used to produce gasses or can be used to reform the input material 102 to be used for sputtering or the like. The reshaping tool 403 may be connected to the solar panels 406 if electricity is required to operate the reshaping tool 403.

In other embodiments, layers of different or similar products 103 can be deposited on top of one another (or accelerated into) to create more complex final products. The thickness of these layers can be adjusted. For example, this can be used to create the different layers of photovoltaic cells.

In other embodiments, the ribbon 401 (or other product) from one of the implementations of this design can be input into another implementation of this design to allow for more complicated products.

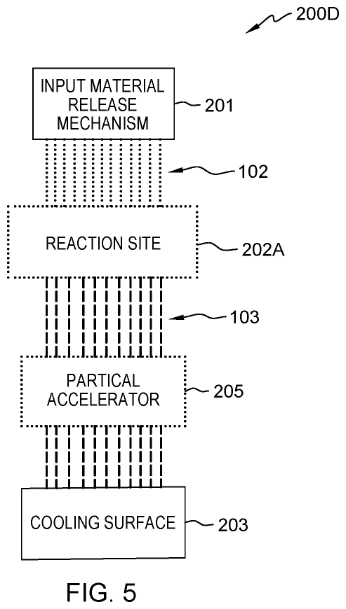

Depicted in FIG. 5 is another embodiment of the decomposition system 200D, in accordance with one embodiment of the present invention. A particle accelerator 205 is incorporated into the system to accelerate the particles before or after they are energized. Given that the energized (or unenergized) products may be ionized or magnetic, an electric field, a magnetic field, or any other mechanism to accelerate the particles into the cooling surface can be used. In particular, this can be used for ion implantation of silicon using a dopant.

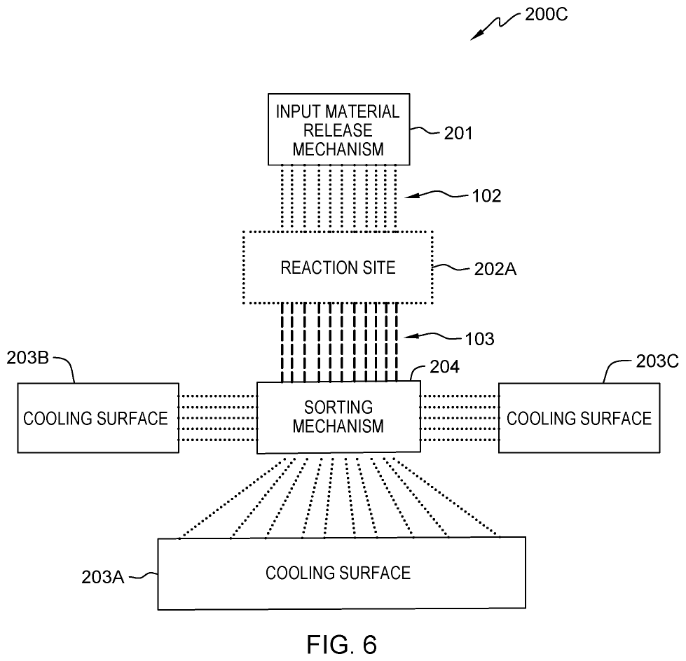

Depicted in FIG. 6 is another embodiment of the decomposition system 200C, in accordance with one embodiment of the present invention. A sorting mechanism 204 is incorporated into the system below the reaction site 202 where different products 103 are formed, and it is desired to separate these different products 103 into separate cooling surfaces 203A, 203B, and 203C. In additional embodiments the number of cooling surfaces/systems can be adjusted based on the number of products 103 which are formed. In the depicted embodiment, the cooling surfaces are shown but similar to FIGS. 3 and 4 a cooling system 400 may be incorporated in. The sorting mechanism 204 sorts the products 103 through, but not limited to, the use of magnetic and/or electrical fields separate these different products 103 to the respective cooling surface (203A, 203B, or 203C). This is possible due to the products 103 being in plasma and where each product has distinct properties which the sorting mechanism 204 is able to distinguish. For example a mass spectrometers can be used to sort the different products 103 based on ions using electric and magnetic fields based on the ions' mass, velocity, and magnetism. Given that the energized (or unenergized) products 103 may be ionized, magnetic, at different temperatures, or have different masses, an electric field, a magnetic field, or any other mechanism based on the different properties of these products 103 can be used to sort them before they come into contact with any of the cooling surfaces 203A, 203B, or 203C.

In another embodiment, the release mechanism 201 may be removed and a quantity of the input material 102 (in a predetermined particle size and layering setup) is placed on the cooling surface 203 and the energy source 400 is designed to articulate and allow the focal point to moves across the layer of the input material 102 to thermally decompose (or otherwise chemically or physically change) the input material 102 to leave behind the purified metal in a predetermined shape, pattern, or design. The energy source has a system to allow for the movement and repositioning of the energy source's heat. The movement of the energy source is at a predetermined speed based on the heat produced, the focal size of the light and the like. It is desired that the energy source moves at a speed which does not overheat or affect the cooling surface. In a similar embodiment, the cooling surface can be removed, and the energy source's heat is directed towards a quantity of the input material 102. In a similar embodiment, the input material 102 can be left on the cooling surface in any arrangement and the energy source is directed towards this input material 102.

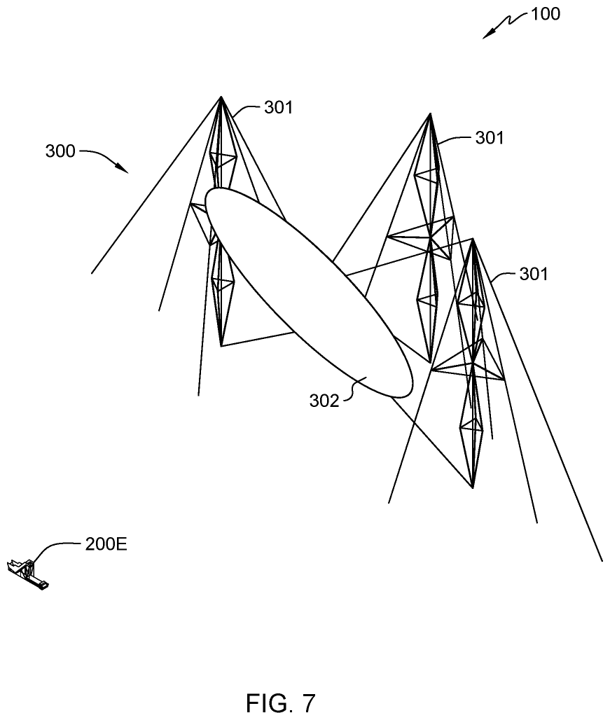

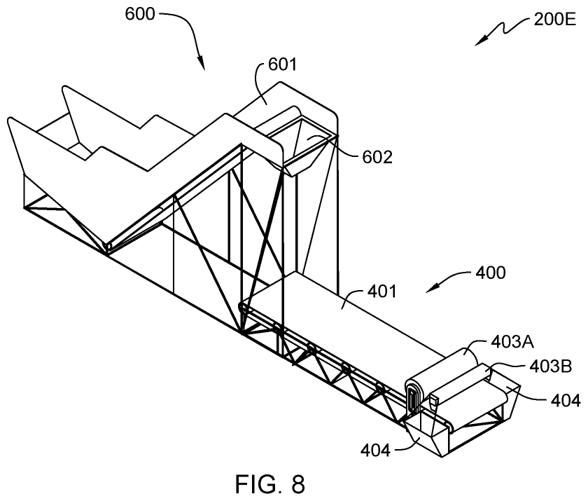

As shown in FIGS. 7 and 8, an embodiment of the decomposition system 200E, in accordance with one embodiment of the present invention. FIG. 7 shows the reflector 302 with the necessary support structure 301 to position the reflector 302 relative to the apparatus 200E. The reflector 203 is made from a reflective material such as mylar or a metal. Wherein the metal may be a product 103 of the reaction. The depicted embodiment shows a large parabolic reflector 302 with large support structures 301. This is due to the necessary size of the reflector 302 to be able to concentrate the solar energy to produce the heat required for the reaction. The support structure 301 may be fixed or may be able to articulate the parabolic reflector 302 as needed through integrated motors and the like. The support structure may also be able to move through integrated motors and the like which could be powered by the solar panels 406. The apparatus 200E is positioned relative to the focal point created by the reflector.

As shown in FIG. 8, a close-up view of the apparatus 200E is shown. The release mechanism 600 is shown having a conveyor belt assembly structure to transfer the input material 102 up to the discharge mechanism 601 to be poured through the reaction site 202. In the depicted embodiment this is a hopper, funnel or the like. Positioned below the discharge mechanism 601 is the ribbon 401 to receive the product 103, which is then feed down the ribbon 401 to the reshaping tools 403A and 403B. In the depicted embodiment, a roller 403A is used to flatten the product 103, and the cutter 403B removes the excess product 103 to limit the size of the product 103 to that of the cutter 403B. The excess which is removed by the cutter 403B is caught in container 404 to be either discarded or used as needed.

While this invention has been described in conjunction with the specific embodiments outlined above, it is evident that many alternatives, modifications, and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A system for thermal decomposition of material comprising:
a release mechanism;
a cooling surface positioned relative to the release mechanism; and
a heat source, positioned relative to the release mechanism and the cooling surface;
wherein a quantity of material is released from the release mechanism and is heated by the heat source, wherein a product is produced and the product is transferred to the cooling surface.

2. The system for thermal decomposition of material of claim 1, wherein the heat source comprises a reflector, and wherein the reflector creates a focused region of heat.

3. The system for thermal decomposition of material of claim 2, wherein the reflector further comprises a series of motors and actuators to adjust the positioning of the reflector.

4. The system for thermal decomposition of material of claim 1, wherein the release mechanism manipulates the particle size of the material.

5. The system for thermal decomposition of material of claim 1, wherein the release mechanism has an adjustable flow rate.

6. The system for thermal decomposition of material of claim 1, further comprising a chamber encapsulating the cooling surface.

7. A system for thermal decomposition of material comprising:
a release mechanism;
a cooling system positioned relative to the release mechanism, wherein the cooling system comprises,
a conveyor belt,
a drive mechanism connected to the conveyor belt, and
a heat source, wherein the heat source is focused relative to the release mechanism and the cooling system;
wherein a quantity of material is released from the release mechanism and is heated by the heat source, wherein a product is produced and the product is transferred to the cooling system.

8. The system for thermal decomposition of material of claim 7, further comprising, a reshaping tool integrated into the conveyor belt.

9. The system for thermal decomposition of material of claim 7, further comprising, a solar panel assembly electrically connected to the cooling system.

10. The system for thermal decomposition of material of claim 7, wherein the conveyor belt is made from the same material as the product.

11. The system for thermal decomposition of material of claim 10, wherein the product is merged into the conveyor belt.

12. The system for thermal decomposition of material of claim 7, wherein the heat source is a heating coil.

13. The system for thermal decomposition of material of claim 7, wherein the heat source, further comprising, a reflector, wherein the reflector focuses the heat source to a focal point.

14. A system for thermal decomposition of material comprising:
a release mechanism;
a cooling system positioned relative to the release mechanism;
a heat source, positioned relative to the release mechanism and the cooling system;
a sorting system positioned relative to the heat source and the cooling system; and
wherein a quantity of material is released from the release mechanism and is heated by the heat source, wherein a product is produced and the product is transferred to the cooling system.

15. The system for thermal decomposition of material of claim 14, further comprising, a reflector, wherein the reflector focuses the heat source to a focal point and wherein the focal point is relative to the release mechanism.

16. The system for thermal decomposition of material of claim 14, wherein the sorting system uses electric fields.

17. The system for thermal decomposition of material of claim 14, wherein the release mechanism manipulates the material particle size to a predetermined size.

18. The system for thermal decomposition of material of claim 14, wherein the release mechanism has an adjustable flow rate.

19. The system for thermal decomposition of material of claim 14, further comprising, a reshaping tool integrated into the cooling system.

20. The system for thermal decomposition of material of claim 16, wherein the sorting system is based on the ions mass, velocity, and magnetism.
